(19) United States
(12) Patent Application Publication
(10) Pub. No.: US 2025/0161863 A1
(43) Pub. Date: May 22, 2025

(54) PRESSURE SWING ADSORPTION METHOD AND SYSTEM FOR REMOVAL OF CO2 FROM AIR

(71) Applicant: THE UNIVERSITY OF SHEFFIELD, Sheffield South Yorkshire (GB)

(72) Inventors: Peter HANDFORD-STYRING, Sheffield South Yorkshire (GB); George Richard Michael DOWSON, Sheffield South Yorkshire (GB)

(21) Appl. No.: 18/832,789

(22) PCT Filed: Jan. 26, 2023
(86) PCT No.: PCT/GB2023/050173

§ 371 Date: Jul. 24, 2024

(30) Foreign Application Priority Data
Jan. 27, 2022 (GB) 2201062.3

(51) Int. Cl. B01D 53/053

(52) U.S. Cl. CPC B01D 53/053; B01D 2257/504; B01D 2258/06; B01D 2259/40009; B01D 2259/402

(57) ABSTRACT

A method for refining carbon dioxide from an input mixed gas stream comprising carbon dioxide, the method comprising; introducing a compressed first portion of the input mixed gas stream into a first adsorption vessel containing carbon dioxide sorbent material to provide a first compressed gas mixture within the first adsorption vessel; venting, from the first adsorption vessel, a carbon dioxide depleted fraction of the first compressed gas mixture; venting, from the first adsorption vessel, an intermediate fraction of the first compressed gas mixture; venting, from the first adsorption vessel, a carbon dioxide enriched fraction of the first compressed gas mixture, wherein the intermediate fraction of the first compressed gas mixture has a concentration of carbon dioxide higher than that of the input gas mixture but lower than that of the enriched fraction of the first compressed gas mixture; collecting the carbon dioxide enriched fraction of the first compressed gas mixture; introducing the intermediate fraction of the first compressed gas mixture and a compressed second portion of the input mixed gas stream into a second adsorption vessel containing carbon dioxide sorbent material to provide a second compressed gas mixture within the second adsorption vessel; venting, from the second adsorption vessel, a carbon dioxide depleted fraction of the second compressed gas mixture; venting, from the second adsorption vessel, a carbon dioxide enriched fraction of the second compressed gas mixture; and collecting the carbon dioxide enriched fraction of the second compressed gas mixture.

### FIELD OF THE INVENTION

The invention relates to methods and systems for refining carbon dioxide from mixed gas input streams, in particular using positive pressure swing adsorption. More specifically, the invention relates to such methods that comprise taking an intermediate fraction during the venting stage of the pressure swing adsorption process, and to systems configured to perform this. The intermediate fraction can be combined with an input mixed gas stream to increase the concentration of carbon dioxide in the input mixed gas stream.

### BACKGROUND

Exhaust gases from industry, combustion, and other carbon-intensive processes contain varying levels of carbon dioxide mixed with other gases, such as nitrogen. It is a known issue that carbon dioxide emissions are a key driver of climate change, but once emitted carbon dioxide is quickly dispersed into the atmosphere and the concentration of the carbon dioxide is diluted to the point that removal is technically and financially challenging. It is therefore desirable to refine (i.e. concentrate) and collect carbon dioxide from various mixed gas sources before it is released into the atmosphere, whereafter it can either be utilised or sequestered.

While complete removal of carbon dioxide from mixed waste gas streams is clearly desirable in some senses, it can be prohibitively expensive and not always necessary. Also, while many carbon dioxide removal technologies aim towards providing a refined carbon dioxide stream having a very high concentration of carbon dioxide, this is not always desirable. For example, where the refined carbon dioxide output is to be used in downstream industries such as construction or agriculture a lower concentration of carbon dioxide may be required, which will require re-dilution of the refined carbon dioxide, thus representing wasted resources in refining the carbon dioxide to unnecessarily high concentrations.

Furthermore, many current carbon dioxide refining technologies are bulky and have a high weight and large footprint, which limits their applicability to applications in which a compact and lightweight system is required. This is particularly the case for aqueous amine scrubbing systems that require heavy aqueous amine solutions. Amine scrubbing processes are also energy intensive as they require the aqueous amine solutions to be heated to high temperatures in order to liberate the chemisorbed carbon dioxide.

Pressure swing adsorption (PSA) processes on the other hand do not rely on heating. In PSA carbon dioxide is adsorbed by a solid sorbent at high pressure in preference to non-polar gases in the input gas stream, such as nitrogen and oxygen. The non-polar gases are then separately vented before carbon dioxide is allowed to desorb from the sorbent at lower pressure, which is then collected. A pressure of 10-30 bar in the adsorption cycle for adsorbing the carbon dioxide is typical.

In comparison to temperature swing methods, PSA is a lower energy technique for which high temperatures are not required during adsorption or desorption.

PSA is also a much faster technique compared to temperature swing as there is no thermal lag, meaning that the adsorb/desorb cycles can be performed relatively rapidly on the timescales of seconds to several minutes.

However, PSA still requires energy to be expended in the compression of the gas. It would also be desirable to increase the throughput of PSA systems, and to reduce their weight and footprint to broaden the number of applications in which they may be deployed.

FR 2890575 A1 discloses an apparatus for vacuum swing adsorption, where vacuum pressures are used to further reduce the pressures in adsorption vessels during venting. The apparatus includes a generic compressor that shares an axle with a turbine driven by the waste gasses. However, the disclosure is broad and not well-defined in terms of other aspects of the process.

There is therefore a need for compact, lightweight, rapid, and energy-efficient means of refining carbon dioxide from mixed gas input streams that provides a tuneable carbon dioxide output concentration over a range of input concentrations to meet requirements.

### SUMMARY OF THE INVENTION

According to a first aspect, the invention provides a method for refining carbon dioxide from an input mixed gas stream comprising carbon dioxide. The method comprises introducing a compressed first portion of the input mixed gas stream into a first adsorption vessel containing carbon dioxide sorbent material to provide a first compressed gas mixture within the first adsorption vessel. The method also comprises venting, from the first adsorption vessel, a carbon dioxide depleted fraction of the first compressed gas mixture having a concentration of carbon dioxide lower than that of the input mixed gas stream. The method also comprises venting, from the first adsorption vessel, an intermediate fraction of the first compressed gas mixture. The method further comprises venting, from the first adsorption vessel, a carbon dioxide enriched fraction of the first compressed gas mixture having a concentration of carbon dioxide higher than that of the input mixed gas stream. The intermediate fraction of the first compressed gas mixture has a concentration of carbon dioxide higher than that of the input gas mixture but lower than that of the enriched fraction of the first compressed gas mixture. The carbon dioxide enriched fraction of the first compressed gas mixture is collected. The intermediate fraction of the first compressed gas mixture and a compressed second portion of the input mixed gas stream are introduced into a second adsorption vessel containing carbon dioxide sorbent material to provide a second compressed gas mixture within the second adsorption vessel. A carbon dioxide depleted fraction of the second compressed gas mixture is vented from the second adsorption vessel. A carbon dioxide enriched fraction of the second compressed gas mixture is vented from the second adsorption vessel; and the carbon dioxide enriched fraction of the second compressed gas mixture is collected.

As the intermediate fraction has a higher carbon dioxide concentration than the input mixed gas stream, it enriches (i.e. increases) the concentration of carbon dioxide in the compressed gas mixture fed into an adsorption vessel of the system in a subsequent PSA cycle by mixing it with the input mixed gas stream. In particular, in a subsequent PSA cycle, the intermediate fraction is combined or mixed with the portion of the input mixed gas stream to provide the compressed gas mixture. Venting and using the intermediate (or “middle”) fraction in this manner may be termed “staged” pressure swing adsorption.

It will be appreciated that the adsorption vessels can effectively be linked to form a chain/cycle, where the intermediate fraction from one adsorption vessel is used with the input mixed gas stream for the next adsorption vessel in the chain/cycle.

The enrichment of the input mixed gas stream used in a PSA cycle using the vented intermediate fraction from a previous PSA cycle provides a number of advantages.

Firstly, the intermediate fraction, while having a higher concentration of carbon dioxide than the input mixed gas stream, would dilute the concentration of the enriched fraction were it included in the enriched fraction. However, simply releasing the vented intermediate fraction without capturing the carbon dioxide would compromise the efficiency of the system. Recycling the intermediate fraction through the system avoids diluting the enriched fraction while at the same time avoiding loss of carbon dioxide from the system.

Secondly, the pressure limits within the adsorption vessel between which the intermediate fraction is vented may be adjusted as required, along with the pressure limits between which the other fractions are vented, in order to tailor the carbon dioxide concentration of the enriched fraction that is output by the system. For example, the lower pressure limit at which the intermediate fraction stops being vented may be reduced to increase the carbon dioxide concentration of the enriched fraction, or may be increased to reduce the carbon dioxide concentration of the enriched fraction. Since the intermediate fraction is recycled through the system rather than vented into the atmosphere, this provides the flexibility to tailor the carbon dioxide concentration of the enriched fraction output by the system without compromising on the amount of carbon dioxide captured by the system. This allows the method to be used to optimise the concentration of carbon dioxide in the enriched fraction for the end application of the enriched fraction. This can enhance the efficiency (e.g. by reducing the energy consumption) of the overall process where the enriched fraction is to be used in an application that does not require high concentrations of carbon dioxide, such as mineralisation and agriculture.

Thirdly, while it is possible to simply feed an enriched fraction back through the system or into a further adsorption vessel to perform a further adsorption/desorption cycle to further increase its carbon dioxide concentration, this still involves the irrecoverable loss of some of the carbon dioxide in the venting of the carbon dioxide depleted fraction in each cycle, and requires further adsorption vessels to be included in the system or the re-use of the same adsorption vessel to perform the further adsorption/desorption cycle. This either increases the footprint, size and complexity of the system by requiring further adsorption vessels and gas compressors to perform the second cycle, or results in the sole adsorption vessel having to perform two cycles in order to get the same output as is possible in a single cycle when using the recycling of the intermediate fraction, increasing the time required to output a final enriched fraction and reducing the capacity of the system.

Fourthly, the capture and refinement of carbon dioxide is more efficient at the higher input carbon dioxide concentrations that result from enriching the input mixed gas stream with the vented intermediate fraction, resulting in a more efficient process.

Fifthly, re-combining an intermediate fraction with the input mixed gas stream for a subsequent cycle can increases the maximum achievable carbon dioxide concentration in the enriched fraction and/or increase the total volume of the enriched fraction produced at a predetermined concentration.

The inventors have determined that the use of an intermediate fraction in this manner can increase the efficiency, yield and/or speed of the method, and/or decrease the footprint of the apparatus used to perform the method.

It will be noted that the collected carbon dioxide enriched fraction of the second compressed gas mixture may be (directly or indirectly) charged into a subsequent vessel.

Where the first and second adsorption vessels are different vessels, preferably the adsorption and/or desorption in the first adsorption vessel is offset in time from the adsorption and/or desorption in the second adsorption vessel. Alternatively or additionally, the method may employ two or more first and/or second (and optionally subsequent) adsorption vessels, wherein the adsorption and/or desorption in the separate adsorption vessels is offset in time from one another. This can provide relatively smooth input and/or output streams compared to embodiments where there is only one adsorption vessel, and/or all adsorption vessels adsorb at substantially the same time.

The method may comprise controlling (e.g. by sequential adjustment) one or more pressures and/or carbon dioxide concentrations during the method or stages thereof, for example to control the efficiency of the method and/or the concentration of carbon dioxide in the enriched fraction.

For example, the method may comprise controlling the pressure of the compressed gas mixture, and/or the pressure range(s) within which the carbon dioxide depleted fraction, the intermediate fraction and/or the enriched fraction is/are vented. The method may comprise controlling the carbon dioxide concentration of the compressed gas mixture, and/or the range(s) of carbon dioxide concentration within which the carbon dioxide depleted fraction and/or the intermediate fraction is/are vented.

In particular, where the lower endpoint of the pressure range within which the carbon dioxide depleted fraction is vented is lowered further, the carbon dioxide concentration of the carbon dioxide depleted fraction will increase. Similarly, where the upper endpoint of the pressure range within which the intermediate fraction is vented is increased, the carbon dioxide concentration of the intermediate fraction will decrease. Where the lower endpoint of the pressure range within which the intermediate fraction is vented is lowered further, the carbon dioxide concentration of the intermediate fraction will increase. Similarly, where the upper endpoint of the pressure range within which the carbon dioxide enriched fraction is vented is increased, the carbon dioxide concentration of the carbon dioxide enriched fraction will decrease.

Furthermore, increasing the carbon dioxide concentration of carbon dioxide in the compressed gas mixture, for example by mixing the input mixed gas stream with the intermediate fraction, can increase the efficiency of the process and/or the enriched fraction. Where the upper endpoint of the carbon dioxide concentration range within which the intermediate fraction is vented is increased further, the carbon dioxide concentration of the intermediate fraction will increase. Similarly, where the lower endpoint of the carbon dioxide concentration range within which the carbon dioxide enriched fraction is vented is decreased, the carbon dioxide concentration of the carbon dioxide enriched fraction will decrease. Where the upper endpoint of the carbon dioxide concentration range within which the intermediate fraction is vented is increased further, the carbon dioxide concentration of the intermediate fraction will increase. Similarly, where the lower endpoint of the carbon dioxide concentration range within which the carbon dioxide enriched fraction is vented is decreased, the carbon dioxide concentration of the carbon dioxide enriched fraction will decrease.

Therefore, the pressures and/or carbon dioxide concentrations used in the method can be controlled, for example, in order to control the efficiency of the method and/or the concentration of carbon dioxide in the enriched fraction.

The method may comprise decompressing the vented carbon dioxide depleted fraction of the first compressed gas mixture, and recovering kinetic energy (and optionally heat energy generated from the kinetic energy) from the carbon dioxide depleted fraction of the first compressed gas mixture. Recovering kinetic energy from the carbon dioxide depleted fraction of the first compressed gas mixture may comprise passing the vented carbon dioxide depleted fraction of the first compressed gas mixture through an energy recovery system to recover kinetic energy from the carbon dioxide depleted fraction of the first compressed gas mixture.

The energy recovery system may comprise an energy recovery unit through which the vented carbon dioxide depleted fraction of the first compressed gas mixture is passed to recover kinetic energy from the carbon dioxide depleted fraction of the first compressed gas mixture. The energy recovery unit may comprise a turbine and/or a piston. The energy recovery unit (e.g. the piston and/or turbine) may be used to generate electricity. Preferably the energy recovery unit comprises a piston configured to recover energy from the carbon dioxide depleted fraction.

Venting, from the first adsorption vessel, the carbon dioxide enriched fraction of the first compressed gas mixture may comprise venting, from the first adsorption vessel, carbon dioxide desorbed from the sorbent material at ambient atmospheric pressure or lower. The carbon dioxide enriched fraction of the first compressed gas mixture may comprise carbon dioxide desorbed from the carbon dioxide sorbent material within the first adsorption vessel at ambient atmospheric pressure or lower. Venting, from the first adsorption vessel, the carbon dioxide enriched fraction of the first compressed gas mixture may comprise venting the carbon dioxide enriched fraction of the first compressed gas mixture to ambient atmospheric pressure or lower. Venting, from the first adsorption vessel, the carbon dioxide enriched fraction of the first compressed gas mixture may comprise reducing the pressure within the first adsorption vessel to ambient atmospheric pressure or lower.

The method may further comprise compressing the first portion of the input mixed gas stream. The first portion of the input mixed gas stream may be compressed by a gas compression system, for example by a gas compressor of the gas compression system, such as a pump.

The compressed first, second and/or subsequent portion of the input mixed gas stream may be introduced into the first adsorption vessel to provide the first/second/subsequent compressed gas mixture within the first/second/subsequent adsorption vessel having a pressure in excess of ambient atmospheric pressure, for example in excess of 10 bar.

The method may be performed at around ambient temperature, i.e. a normal atmospheric temperature surrounds the apparatus with which the method is performed, and as such can be performed without heating and/or cooling (e.g. active heating and/or cooling). For example, the method may be performed in an ambient temperature of from −10° C. to 50° C., such as from 0° C. to 40° C., or from 5° C. to 35° C., for example from 10° C. to 30° C., such as from 15° C. to 30° C., or from 20° C. to 25° C. This can provide the benefits that heating/cooling equipment is not necessary and that the method is more energy efficient than a method that would require heating/cooling.

It will be understood that the carbon dioxide sorbent material contained in the second absorption vessel adsorbs carbon dioxide from the second compressed gas mixture. It will be understood that the carbon dioxide depleted fraction of the second compressed gas mixture has a concentration of carbon dioxide lower than that of the input mixed gas stream, and that the carbon dioxide enriched fraction of the second compressed gas mixture has a concentration of carbon dioxide higher than that of the input mixed gas stream.

The method may further comprise decompressing the vented carbon dioxide depleted fraction of the second compressed gas mixture, and recovering kinetic energy from the carbon dioxide depleted fraction of the second compressed gas mixture resulting from or imparted by its decompression.

Recovering kinetic energy from the carbon dioxide depleted fraction of the second compressed gas mixture may comprise passing the vented carbon dioxide depleted fraction of the second compressed gas mixture through the energy recovery system to recover kinetic energy from the carbon dioxide depleted fraction of the second compressed gas mixture.

The energy recovery system may comprise a second energy recovery unit through which the vented carbon dioxide depleted fraction of the second compressed gas mixture is passed to recover kinetic energy from the carbon dioxide depleted fraction of the second compressed gas mixture. The second energy recovery unit may comprise a turbine and/or a piston. The first and second energy recovery units may be the same energy recovery unit. Energy recovery units are discussed in more detail below.

The method may further comprise compressing the second portion of the input mixed gas stream, for example by the gas compression system.

The method may comprise compressing a second portion of the input mixed gas stream, for example by the gas compression system.

The method may comprise compressing the intermediate fraction of the first compressed gas mixture, for example by the gas compression system.

The pressure of the first/second/subsequent compressed gas mixture may be in excess of ambient atmospheric pressure, e.g. 10 bara or more, or 11 bara or more, such as 12 bara or more, or 15 bara or more. Higher pressures are beneficial because they reduce the amount of sorbent material required to separate a given quantity of carbon dioxide. Thus, higher pressures can reduce the footprint of the apparatus.

The pressure may be 40 bara or less, or 30 bara or less, for example 25 bara or less, preferably 20 bara or less. Pressures of more than about 40 bara are generally not useful because carbon dioxide is liquid above about 40 bara. The pressure may be from 10 to 40 bara, such as from 12 to 40 bara, or from 12 to 30 bara, preferably from 15 to 20 bara.

The method may further comprise introducing the vented intermediate fraction of the first compressed gas mixture and the compressed second portion of the input mixed gas stream into a compressed gas buffer vessel. The method may further comprise storing the vented intermediate fraction of the first compressed gas mixture and the compressed second portion of the input mixed gas stream in the compressed gas buffer vessel. The method may further comprise introducing the intermediate fraction of the first compressed gas mixture and the compressed second portion of the input mixed gas stream into the second adsorption vessel from the compressed gas buffer vessel.

The method may further comprise compressing the vented intermediate fraction of the first compressed gas mixture and introducing the compressed vented intermediate fraction of the first compressed gas mixture into the compressed gas buffer vessel. The vented intermediate fraction of the first compressed gas mixture may be compressed by the gas compression system. The vented intermediate fraction of the first compressed gas mixture may be compressed by a gas compressor of the gas compression system.

The first adsorption vessel and the second adsorption vessel may be the same adsorption vessel. The first and second adsorption vessels may be refer to as “an adsorption vessel”, meaning that they can be either the same adsorption vessel or different adsorption vessels without limitation.

The method may be defined as comprising performing a plurality of pressure swing adsorption (PSA) cycles. Each of the plurality of pressure swing adsorption cycles may comprise; compressing a portion of the input mixed gas stream; introducing the compressed portion of the input mixed gas stream into an adsorption vessel containing carbon dioxide sorbent material to provide a compressed gas mixture within the adsorption vessel; adsorbing, by the carbon dioxide sorbent material, carbon dioxide from the compressed gas mixture; venting, from the adsorption vessel, a carbon dioxide depleted fraction of the compressed gas mixture having a percentage by weight concentration of carbon dioxide lower than that of the input mixed gas stream; venting, from the adsorption vessel, a carbon dioxide enriched fraction of the compressed gas mixture having a concentration of carbon dioxide higher than that of the input mixed gas stream; and collecting the carbon dioxide enriched fraction of the compressed gas mixture. Each of the PSA cycles may comprise decompressing the vented carbon dioxide depleted fraction of the compressed gas mixture through an energy recovery unit to recover kinetic energy from the carbon dioxide depleted fraction of the compressed gas mixture.

Each of a first subset of the pressure swing adsorption cycles may further comprise venting, from the adsorption vessel, an intermediate or middle fraction of the compressed gas mixture having a concentration of carbon dioxide higher than that of the input gas mixture but lower than that of the enriched fraction of the compressed gas mixture. The vented intermediate fraction from each of the first subset of the pressure swing adsorption cycles may be introduced into the adsorption vessel along with the compressed portion of the input mixed gas stream to provide the compressed gas mixture within the adsorption vessel in a subsequent one of the plurality of pressure swing adsorption cycles.

Each of a second subset of the pressure swing adsorption cycles may further comprise introducing the intermediate fraction from one of the first subset of pressure swing absorption cycles into the adsorption vessel along with the compressed portion of the input mixed gas stream to provide the compressed gas mixture within the adsorption vessel.

The first subset may comprise all but the final one of the plurality of pressure swing adsorption cycles. The second subset may comprise all but the first of the plurality of pressure swing absorption cycles. The method may comprise further pressure swing absorption cycles in addition to the plurality of pressure swing absorption cycles

According to a second aspect, the invention provides a pressure swing adsorption system for performing a method in accordance with the invention, for example as set out above. The system is capable of performing such a method, and may therefore comprise any or all of the component parts of the system described herein as required.

According to a third aspect, the invention provides a pressure swing adsorption system for refining carbon dioxide from an input mixed gas stream comprising carbon dioxide. The system may comprise a gas inlet for receiving an input mixed gas stream. The system may comprise a gas compression system in fluid communication with the gas inlet. The system may comprise a first adsorption vessel containing carbon dioxide sorbent material. The first adsorption vessel may be in fluid communication with the gas compression system and configured to receive gas compressed by the gas compression system. The system comprises a second adsorption vessel containing carbon dioxide sorbent material, the second adsorption vessel in fluid communication with the gas compression system and configured to receive gas compressed by the gas compressor. The system is configured to; vent, from the first adsorption vessel, an intermediate fraction of the first compressed gas mixture having a concentration of carbon dioxide higher than that of the input gas mixture but lower than that of the enriched fraction of the first compressed gas mixture; compress, using the gas compression system, a second portion of the input mixed gas stream; introduce the intermediate fraction of the first compressed gas mixture and the compressed second portion of the input mixed gas stream into the first or second adsorption vessel to provide a second compressed gas mixture within the first or second adsorption vessel; vent, from the first or second adsorption vessel, a carbon dioxide depleted fraction of the second compressed gas mixture; and vent, from the first or second adsorption vessel, a carbon dioxide enriched fraction of the second compressed gas mixture. The system of the third aspect may be configured to perform the method of the first aspect.

The system of the second aspect and/or the third aspect may include one or more sampling vessels for determining the concentration of carbon dioxide. The concentration of carbon dioxide determined may be used to optimise the system, for example by optimising the concentration of carbon dioxide in the enriched fraction. The or each sampling vessel may be in fluid communication with one or more adsorption vessels and/or one or more outputs from the or each sampling vessel.

Pressure swing adsorption systems according to the invention have been produced that have a small footprint compared to conventional systems. For example, the system may have an output of 1 tonne or more, such as 10 tonnes or more, of enriched fraction per day, in a footprint comparable to a 20 foot (6 meter) ISO shipping container. The system may be portable, allowing for reduced construction and installation times.

The system may comprise an energy recovery system in fluid communication with the first adsorption vessel. The energy recovery system may be configured to recover kinetic energy resulting from the decompression of compressed gas vented from the first adsorption vessel.

The energy recovery system may be configured to recover kinetic energy resulting from the decompression of a carbon dioxide depleted portion of the compressed gas vented from the first adsorption vessel.

The system may further comprise a controller configured to control the system to perform any or all of the steps of a method in accordance with the invention, as described herein. In particular, the controller may be configured to control the system to compress, using the gas compression system, a first portion of the input mixed gas stream; introduce the compressed first portion of the input mixed gas stream into the first adsorption vessel to provide a first compressed gas mixture within the first adsorption vessel; vent, from the first adsorption vessel, a carbon dioxide depleted fraction of the first compressed gas mixture; and vent, from the first adsorption vessel, a carbon dioxide enriched fraction of the first compressed gas mixture. The controller may be configured to control the system to decompress the vented carbon dioxide depleted fraction of the first compressed gas mixture, and pass the vented carbon dioxide depleted fraction of the first compressed gas mixture through the energy recovery system to recover kinetic energy from the carbon dioxide depleted fraction of the first compressed gas mixture.

The controller may be configured to control the system to; vent, from the first adsorption vessel, an intermediate fraction of the first compressed gas mixture having a concentration of carbon dioxide higher than that of the input gas mixture but lower than that of the enriched fraction of the first compressed gas mixture; compress, using the gas compression system, a second portion of the input mixed gas stream; compress, using the gas compression system, the intermediate fraction of the first compressed gas mixture; introduce the intermediate fraction of the first compressed gas mixture and the compressed second portion of the input mixed gas stream into the first or second adsorption vessel to provide a second compressed gas mixture within the first or second adsorption vessel; vent, from the first or second adsorption vessel, a carbon dioxide depleted fraction of the second compressed gas mixture; and vent, from the first or second adsorption vessel, a carbon dioxide enriched fraction of the second compressed gas mixture.

The system may further comprise a first gas return path in fluid communication with the first adsorption vessel and an inlet of the gas compression system. The first gas return path may be arranged to return the intermediate fraction of the first compressed gas mixture to the gas compressor for compression prior to the introduction of the intermediate fraction of the first compressed gas mixture into the first or second adsorption vessel.

The controller may be configured to control the system to decompress the vented carbon dioxide depleted fraction of the second compressed gas mixture, and pass the vented carbon dioxide depleted fraction of the second compressed gas mixture through the energy recovery system to recover kinetic energy from the carbon dioxide depleted fraction of the second compressed gas mixture.

The system may further comprise a compressed gas buffer vessel in fluid communication with the gas compression system and the first adsorption vessel. The compressed gas buffer vessel may be configured or arranged to receive and store compressed gas compressed by the gas compression system prior to the compressed gas being introduced into the first adsorption vessel.

The first gas return path may be arranged to return the intermediate fraction of the first compressed gas mixture to the compressed gas buffer vessel prior to the introduction of the intermediate fraction of the first compressed gas mixture into the first or second adsorption vessel.

The system may comprise a plurality of adsorption vessels, each in fluid communication with a respective gas return path that is in fluid communication with an inlet of the gas compression system and/or the compressed gas buffer vessel.

The present disclosure refers to the concentration of carbon dioxide. The skilled person will appreciate that this means the proportion of carbon dioxide with respect to other gases in a sample, i.e. the mole fraction of carbon dioxide in the sample. This may be expressed in vol %. The skilled person would understand that, in the context of the present invention, an increase in concentration of carbon dioxide in a sample does not include simply compressing the sample, for example.

The present disclosure provides the subject-matter of the following clauses;

1. A method for refining carbon dioxide from an input mixed gas stream comprising carbon dioxide, the method comprising; introducing a compressed first portion of the input mixed gas stream into a first adsorption vessel containing carbon dioxide sorbent material to provide a first compressed gas mixture within the first adsorption vessel; venting, from the first adsorption vessel, a carbon dioxide depleted fraction of the first compressed gas mixture; decompressing the vented carbon dioxide depleted fraction of the first compressed gas mixture; recovering kinetic energy from the carbon dioxide depleted fraction of the first compressed gas mixture resulting from decompression of the vented carbon dioxide depleted fraction of the first compressed gas mixture; venting, from the first adsorption vessel, a carbon dioxide enriched fraction of the first compressed gas mixture; and collecting the carbon dioxide enriched fraction of the first compressed gas mixture.

2. The method of clause 1, wherein recovering kinetic energy from the carbon dioxide depleted fraction of the first compressed gas mixture comprises passing the vented carbon dioxide depleted fraction of the first compressed gas mixture through an energy recovery system to recover the kinetic energy from the carbon dioxide depleted fraction of the first compressed gas mixture.

3. The method of clause 2, wherein the energy recovery system comprises an energy recovery unit through which the vented carbon dioxide depleted fraction of the first compressed gas mixture is passed to recover the kinetic energy from the carbon dioxide depleted fraction of the first compressed gas mixture.

4. The method of clause 3, wherein the energy recovery unit comprises a turbine.

5. The method of any preceding clause, further comprising compressing the first portion of the input mixed gas stream.

6. The method of clause 5, wherein the first portion of the input mixed gas stream is compressed by a gas compression system.

7. The method of any preceding clause, wherein venting, from the first adsorption vessel, the carbon dioxide enriched fraction of the first compressed gas mixture comprises venting, from the first adsorption vessel, carbon dioxide desorbed from the sorbent material at ambient atmospheric pressure or lower.

8. The method of any preceding clause, wherein the compressed first portion of the input mixed gas stream is introduced into the first adsorption vessel to provide the first compressed gas mixture within the first adsorption vessel having a pressure in excess of ambient atmospheric pressure.

9. The method of any preceding clause, further comprising; venting, from the first adsorption vessel, an intermediate fraction of the first compressed gas mixture having a concentration of carbon dioxide higher than that of the input gas mixture but lower than that of the enriched fraction of the first compressed gas mixture; introducing the intermediate fraction of the first compressed gas mixture and a compressed second portion of the input mixed gas stream into a second adsorption vessel containing carbon dioxide sorbent material to provide a second compressed gas mixture within the second adsorption vessel; venting, from the second adsorption vessel, a carbon dioxide depleted fraction of the second compressed gas mixture; venting, from the second adsorption vessel, a carbon dioxide enriched fraction of the second compressed gas mixture; and collecting the carbon dioxide enriched fraction of the second compressed gas mixture.

10. The method of clause 9, further comprising; introducing the vented intermediate fraction of the first compressed gas mixture and the compressed second portion of the input mixed gas stream into a compressed gas buffer vessel; and introducing the intermediate fraction of the first compressed gas mixture and the compressed second portion of the input mixed gas stream into the second adsorption vessel from the compressed gas buffer vessel.

11. The method of clause 10, further comprising; compressing the vented intermediate fraction of the first compressed gas mixture and introducing the compressed vented intermediate fraction of the first compressed gas mixture into the compressed gas buffer vessel.

12. The method of any one of clauses 9 to 11, wherein the first adsorption vessel and the second adsorption vessel are the same adsorption vessel.

13. A pressure swing adsorption system for performing the method of any preceding clause.

14. A pressure swing adsorption system for refining carbon dioxide from an input mixed gas stream comprising carbon dioxide, the system comprising; a gas inlet for receiving an input mixed gas stream; a gas compression system in fluid communication with the gas inlet; a first adsorption vessel containing carbon dioxide sorbent material, the first adsorption vessel in fluid communication with the gas compression system and configured to receive gas compressed by the gas compression system; and an energy recovery system in fluid communication with the first adsorption vessel, the energy recovery system configured to recover kinetic energy resulting from the decompression of compressed gas vented from the first adsorption vessel.

15. The system of clause 14, wherein the energy recovery system is configured to recover kinetic energy resulting from the decompression of a carbon dioxide depleted portion of the compressed gas vented from the first adsorption vessel.

16. The system of clause 14 or 15, further comprising a controller configured to control the system to; compress, using the gas compression system, a first portion of the input mixed gas stream; introduce the compressed first portion of the input mixed gas stream into the first adsorption vessel to provide a first compressed gas mixture within the first adsorption vessel; vent, from the first adsorption vessel, a carbon dioxide depleted fraction of the first compressed gas mixture; decompress the vented carbon dioxide depleted fraction of the first compressed gas mixture; pass the vented carbon dioxide depleted fraction of the first compressed gas mixture through the energy recovery system to recover kinetic energy from the carbon dioxide depleted fraction of the first compressed gas mixture; and vent, from the first adsorption vessel, a carbon dioxide enriched fraction of the first compressed gas mixture.

17. The system of clause 16, wherein the system optionally comprises a second adsorption vessel containing carbon dioxide sorbent material, the second adsorption vessel in fluid communication with the gas compression system and configured to receive gas compressed by the gas compressor; and wherein the controller is configured to control the system to; vent, from the first adsorption vessel, an intermediate fraction of the first compressed gas mixture having a concentration of carbon dioxide higher than that of the input gas mixture but lower than that of the enriched fraction of the first compressed gas mixture; compress, using the gas compression system, a second portion of the input mixed gas stream; introduce the intermediate fraction of the first compressed gas mixture and the compressed second portion of the input mixed gas stream into the first or second adsorption vessel to provide a second compressed gas mixture within the first or second adsorption vessel; vent, from the first or second adsorption vessel, a carbon dioxide depleted fraction of the second compressed gas mixture; and vent, from the first or second adsorption vessel, a carbon dioxide enriched fraction of the second compressed gas mixture.

18. The system of clause 17, further comprising a first gas return path in fluid communication with the first adsorption vessel and an inlet of the gas compression system, the first gas return path configured to return the intermediate fraction of the first compressed gas mixture to the gas compressor for compression prior to the introduction of the intermediate fraction of the first compressed gas mixture into the first or second adsorption vessel.

19. The system of clause 17 or clause 18, wherein the controller is configured to control the system to; decompress the vented carbon dioxide depleted fraction of the second compressed gas mixture; and pass the vented carbon dioxide depleted fraction of the second compressed gas mixture through the energy recovery system to recover kinetic energy from the carbon dioxide depleted fraction of the second compressed gas mixture.

20. The system of any one of clauses 14 to 19, further comprising; a compressed gas buffer vessel in fluid communication with the gas compression system and the first adsorption vessel, the compressed gas buffer vessel configured receive and store compressed gas compressed by the gas compression system prior to the compressed gas being introduced into the first adsorption vessel.

### BRIEF DESCRIPTION OF THE FIGURES

The invention will now be described, by way of example only, with reference to the accompanying drawings, in which;

FIG. 1 shows a schematic diagram of a pressure swing adsorption system in accordance with the invention;

FIG. 2 shows a photograph of a system in accordance with the invention, which is configured to perform method in accordance with the invention;

FIG. 3 is a graph showing relative pressures in various components of the system shown in FIG. 2, during operation;

FIG. 4 is a graph showing the variation in output concentration of carbon dioxide from the system shown in FIG. 2 over time; and

FIG. 5 is a graph showing the variation in output concentration of carbon dioxide from the system shown in FIG. 2 over time, during an extended vent stage.

### DETAILED DESCRIPTION

The following description is intended to introduce various aspects and features of the invention in a non-limiting manner. For clarity and brevity, features and aspects of the invention may be described in the context of particular embodiments. However, it should be understood that features of the invention that are described only in the context of one or more embodiments may be employed in the invention in the absence of other features of those embodiments, particularly where there is no inextricable functional interaction between those features. Even where some functional interaction between the features of an embodiment is discernible, it is to be understood that those features are not inextricably linked if the embodiment would still fulfil the requirements of the invention without one or more of those features being present. Thus, where features are, for brevity, described in the context of a single embodiment, those features may also be provided separately or in any suitable sub-combination. It should also be noted that features that are described in the context of separate aspects and embodiments of the invention may be used together and/or be interchangeable wherever possible. Features described in connection with the invention in different contexts (e.g. a method or system) may each have corresponding features definable and/or combinable with respect to each other, and these embodiments are specifically envisaged.

The invention utilises pressure swing adsorption (PSA) to refine carbon dioxide from mixed gas input streams. The mixed gas input stream comprises a gas mixture comprising carbon dioxide. Generally, the mixed gas input stream is a waste or exhaust gas stream, and generally comprises less than 20 wt. % carbon dioxide, but the exact carbon dioxide concentration of the mixed gas input stream is not critical and the invention may be adapted to refine carbon dioxide from input streams having various carbon dioxide concentrations to output a carbon dioxide enriched fraction having a tuneable carbon dioxide concentration. The invention therefore provides a method of refining exhaust or waste gases to provide a stream of refined carbon dioxide which can be used as a feedstock for industrial processes or stored as a means of mitigation.

Unless otherwise stated, where concentrations are referred to herein, these refer to concentrations by weight, specifically a weight percent, or wt. %, sometimes referred to as a % wt./wt.

The invention utilises positive pressure swing adsorption, in which the input mixed gas stream is compressed to increase its pressure above atmospheric pressure. Carbon dioxide is then adsorbed by the solid sorbent at this increased pressure, whereafter the unadsorbed gases are vented, the pressure allowed to reduce, typically to atmospheric pressure or lower, and carbon dioxide desorbed from the sorbent at the reduced pressure then collected.

It will be understood that the term “vented” does not necessarily mean that gases are vented to the atmosphere. The gases may be transferred to a different vessel after being vented from one vessel, for example. Preferably intermediate fractions are vented into subsequent vessels for combining with the input mixed gas stream, such that a “chain” is formed between the vessels. The chain may be circular, rather than linear, so that two or more, such as three or four or more adsorption vessels are used in a cycle.

By refining carbon dioxide it is meant that the output gas stream has a higher concentration of carbon dioxide than the input mixed gas stream. In other words, carbon dioxide refinement comprises concentrating carbon dioxide. Carbon dioxide refining therefore involves the capture of at least a portion of the carbon dioxide present in the input gas stream and outputting this at a higher concentration than that of the input gas stream.

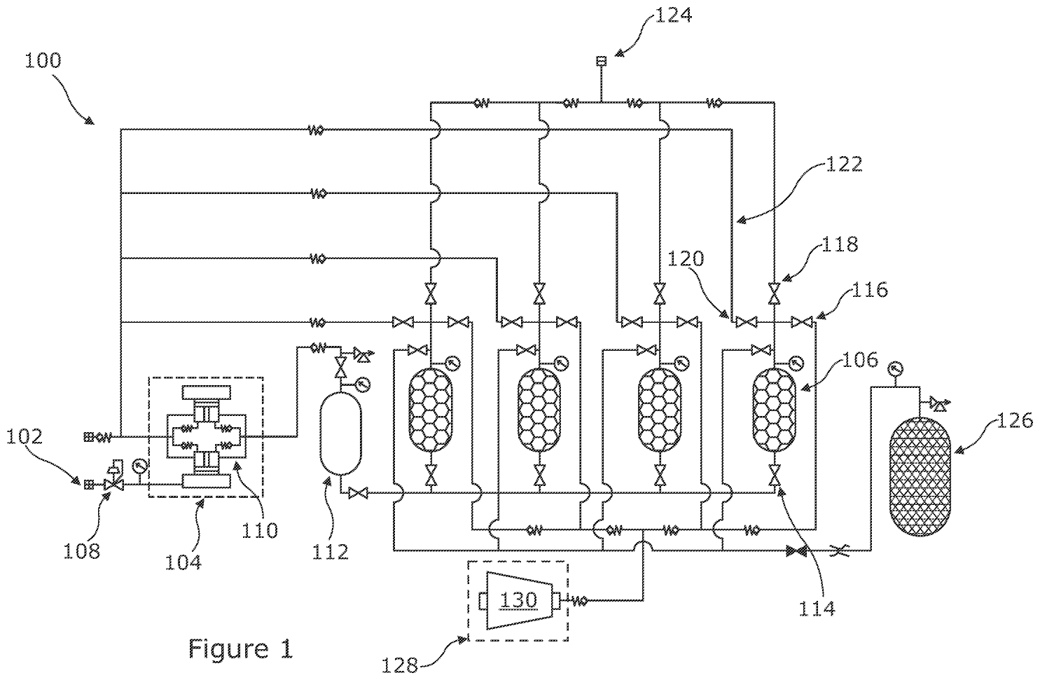

Referring to FIG. 1, a pressure swing adsorption system 100 in accordance with the invention comprises a gas inlet 102 for receiving an input mixed gas stream, a gas compression system 104, and one or more adsorption vessels 106.

The gas inlet 102 provides fluid communication between the system 100 and a mixed gas input stream and may be provided with an inlet valve 108 for controlling the admittance of the input mixed gas stream into the system 100.

The gas compression system 104 comprises at least one gas compressor 110, and may also comprise additional gas compressors. For example, the system illustrated in FIG. 1 comprises a single gas compressor 110 in fluid communication with the gas inlet 102, but it would instead be possible for the gas compression system to comprise multiple gas compressors. For example, a separate gas compressor could be used to compress the input mixed gas stream into each of the adsorption vessels 106 rather than a single compressor being used to provide compressed gas to all of the adsorption vessels. The gas compressor(s) may be any suitable type of gas compressor, such as a pump.

The system may comprise a compressed gas buffer vessel 112, in fluid communication with the gas compression system 104 for receiving and storing compressed gas compressed by the gas compression system 104 prior to the compressed gas being introduced into a selected one of the adsorption vessels 106. The compressed gas buffer vessel 112 is located downstream from the gas compressor 110 and upstream of the adsorption vessels 106. The compressed gas buffer vessel 112 provides a number of advantages. Firstly, the input mixed gas stream may be compressed and delivered to the compressed gas buffer vessel 112 while the adsorption vessels are performing adsorption/desorption cycles, thus allowing the portion of the input mixed gas stream that is to be used in a subsequent adsorption/desorption cycle to be pre-compressed and stored in readiness for delivery to one of the adsorption vessels 106 once an adsorption vessel becomes available following the completion of an adsorption/desorption cycle. This removes the delay that is otherwise caused if the input mixed gas stream is compressed directly into the adsorption vessels 106 without pre-compression and storage in the compressed gas buffer vessel 112. The pre-compression and storage of the input mixed gas stream also means that compression of the input mixed gas stream can be performed more slowly without affecting the PSA cycle time of the system and a smaller or slower compressor may be utilised than would otherwise be required to compress the input mixed gas stream into the adsorption vessels 106 directly. The compressed gas buffer vessel 112 also provides a container for controlled mixing of the input mixed gas stream with an intermediate or middle fraction vented from one of the adsorption vessels 106 in a previous pressure swing adsorption cycle, as will be described in further detail below. The compressed gas buffer vessel 112 may be in fluid communication with the gas compressor 110 via a buffer vessel inlet valve for controlling the flow of gas from the gas compressor into the compressed gas buffer vessel 112 and may be in fluid communication with the adsorption vessels 106 via a buffer vessel outlet valve for controlling the supply of compressed gas from the compressed gas buffer vessel 112 to the adsorption vessels 106.

The system may comprise a single or a plurality of adsorption vessels 106. If a plurality of adsorption vessels are present, these may be arranged in fluid communication with the gas compressor 110 and, if present, the compressed gas buffer vessel 112, a parallel arrangement as shown such that each of the adsorption vessels 106 may be supplied with compressed gas from the gas compressor 110/compressed gas buffer vessel 112. Each of the adsorption vessels 106 contains carbon dioxide sorbent material capable of adsorbing carbon dioxide. The carbon dioxide sorbent material preferentially adsorbs carbon dioxide compared to non-polar gases in the mixed gas input stream, such as nitrogen or oxygen. The amount of carbon dioxide adsorbed by the sorbent material increases as the pressure increases. This means that carbon dioxide is adsorbed by the sorbent material when the compressed mixed gas is introduced into an adsorption vessel 106, thereby depleting or reducing the concentration of carbon dioxide within the compressed mixed gas, and is then desorbed once a carbon dioxide depleted fraction of the compressed mixed gas is vented from the adsorption vessel 106 to reduce the pressure within the adsorption vessel 106. The desorbed carbon dioxide may then be collected as part of a carbon dioxide enriched fraction. The sorbent material is typically solid sorbent material and may be provided as a matrix or beads within the adsorption vessel 106. Various solid carbon dioxide sorbents are known and may be utilised in the context of the invention, such as silica-based sorbents and hyper crosslinked polymers (HCPs). Other solid carbon dioxide sorbent materials include zeolites, activated carbon, activated alumina, silica gel, and molecular sieves. Solid sorbent materials provide the benefit that they are easier to separate from gases than liquid sorbent materials. Preferably the sorbent material is amine-free (i.e. not amine-based), which provides the benefits of avoiding evaporative loss and decomposition.

Each of the adsorption vessels 106 may be provided with various valves to control the introduction and venting of the various gas mixtures and gas fractions into and from the adsorption vessel 106. The valves may include an inlet valve 114 for controlling the flow of gas from the gas compression system 104/compressed gas buffer vessel 112 into the adsorption vessel 106. Each of the adsorption vessels 106 may also be provided with an outlet valve 116 for venting a carbon dioxide depleted compressed gas fraction from the adsorption vessel 106, an outlet valve 118 for venting a carbon dioxide enriched compressed gas fraction from the adsorption vessel 106, and an outlet valve 120 for venting an intermediate or middle fraction of the compressed gas from the adsorption vessel 106. Each of the outlet valves 120 for venting an intermediate compressed gas fraction from the adsorption vessels 106 may be arranged to provide for fluid communication between the adsorption vessel 106 and the compressed gas buffer vessel 112 via a respective gas return path 122, optionally via the gas compression system 104/gas compressor 110, and may therefore permit return of the intermediate fraction to the compressed gas buffer vessel 112, optionally via the gas compression system 104/gas compressor 110. The outlet valves 118 for venting a carbon dioxide enriched compressed gas fraction from the adsorption vessels may provide for fluid communication of the adsorption vessels 106 with an outlet port 124 of the system 100 for collecting the carbon dioxide enriched fractions of the compressed gas.

The system 100 may comprise a sampling vessel 126 in fluid communication with each of the adsorption vessels 106 via a further outlet valve used to calibrate and optimise the system by taking portions of output gas from the adsorption vessels 106 so that the carbon dioxide concentration can be accurately measured, for example using infrared carbon dioxide sensors. Preferably the or each sampling vessel is in fluid communication with one or more depleted, intermediate and/or enriched outputs from the or each sampling vessel. Preferably each depleted, intermediate and/or enriched output from the or each sampling vessel is equipped with a sampling vessel. More preferably all depleted, intermediate and enriched outputs from the or each sampling vessel are equipped with a sampling vessel. The or each sampling vessel may be fitted with a valve on the input to the sampling vessel, to control the gases entering the sampling vessels. Preferably the or each sampling vessel is equipped with a carbon dioxide sensor. Carbon dioxide sensors include infrared carbon dioxide sensors, such as a nondispersive infrared sensor.

Each adsorption vessel may include a pressure sensor.

The system 100 may further comprise an energy recovery system 128 for recovering kinetic energy from compressed gas that is vented from the adsorption vessels 106 and is allowed to decompress, thus recovering energy that was used in compressing the gas and improving the energy efficiency of the system. In particular, the energy recovery system 128 may be arranged to recover kinetic energy from the carbon dioxide depleted fraction of the compressed gas vented from the adsorption vessels 106 as it decompresses. The kinetic energy results from the decompression of the gas, and may be recovered by passing the gas through the energy recovery system 128. The energy recovery system 128 is therefore arranged in fluid communication with the adsorption vessels 106 and is configured to recover kinetic energy resulting from decompression of compressed gas that is vented from the adsorption vessels 106. The energy recovery system 128 may be provided downstream of the outlet valves 116 for venting the carbon dioxide depleted compressed gas fraction from the adsorption vessels 106. The energy recovery system 128 may comprise one or more energy recovery units, such as turbines and/or pistons, through which the vented gas passes as it decompresses. A single energy recovery unit 130 may be provided through which the vented carbon dioxide depleted fraction from each of the adsorption vessels 106 passes, or the energy recovery system 128 may comprise separate energy recovery units to recover energy from the vented carbon dioxide depleted fraction from each of the adsorption vessels 106.

Preferably the recovered energy is used to compress the input mixed gas stream (i.e. power a compressor of the input mixed gas stream), for example using a piston and/or a screw compressor. The compressor of the input mixed gas stream may be powered directly or indirectly (e.g. by generating electricity from the vented carbon dioxide depleted fraction and using the electricity to power the compressor).

As an example of directly powering the compressor, preferably the energy recovery unit comprises a reciprocating pump (i.e. a double-action piston pump) configured to recover energy, for example by compressing the input mixed gas stream. Alternatively, the energy recovery unit may comprise a piston or a turbine configured to drive at least one screw of a screw compressor. Screw compressors are typically favoured for larger scale applications.

This way, the vented carbon dioxide depleted fraction (typically mostly made up of nitrogen), which is typically vented at high pressure, may be configured to power a compressor for the input mixed gas stream for a subsequent cycle. Therefore, the method may comprise using the recovered energy to compress the input mixed gas stream for a subsequent cycle. It will be appreciated that the recovered energy will be less than the energy required to sufficiently compress the volume of input mixed gas stream as required for the process. Thus, in addition to the use of the recovered energy, the method may also include other means to top up/further compress the input mixed gas stream.

Where the vented carbon dioxide depleted fraction is configured to power a compressor for the input mixed gas stream for a subsequent cycle, the system should preferably be configured to provide a higher pressure input mixed gas stream than the vented carbon dioxide depleted fraction. Preferably the reciprocating pump has an area ratio of 1:1 or greater, such as 2:1 or greater, or 4:1 or greater, such as 5:1 or greater, or 6:1 or greater. The reciprocating pump may have an area ratio of from 1:1 to 100:1, such as from 2:1 to 50:1, or from 2:1 to 30:1, preferably from 2:1 to 20:1, or from 2:1 to 15:1, for example from 4:1 to 12:1, or from 4:1 to 10:1. For example, using a reciprocating pump with an area ratio of 7:1 would provide a input mixed gas stream pressure of 21 bar from a vented carbon dioxide depleted fraction having a pressure of 3 bar.

In addition to or instead of the kinetic energy recovery system 128 described above, the system may also or alternatively comprise a heat energy recovery system to recover heat energy imparted to the compressed gas due to its compression. For example, the system may comprise one or more heat exchangers arranged to recover heat energy from compressed gas (e.g. the compressed portions of the input mixed gas stream that are passed through the system) contained in the compressed gas buffer vessel 112 and/or the adsorption vessels 106.

The system 100 may also comprise a controller configured to control the operation of the system 100. The controller may be configured to control the system 100 to perform any of the steps of the methods of the invention as described herein, and may therefore be configured to control the various valves and other component parts of the system 100, namely the gas compression system 104/gas compressor 110. The controller may comprise one or more computer processors together with computer-readable instructions loaded onto one or more memories that, when executed by the processor(s), cause the system to perform any or all of the steps of the method of the invention as described herein.

The system 100 may be operated to perform a method for refining carbon dioxide from a mixed gas input stream comprising carbon dioxide in accordance with the invention. The method may comprise performing a plurality of PSA cycles that may each be performed in the same way or comprise some or all of the same steps. A first of the plurality of PSA cycles may be performed as follows. A first portion of the input mixed gas stream may be compressed by the gas compression system 104, namely by the gas compressor 110. The compressed first portion of the input mixed gas stream may be introduced into the compressed gas buffer vessel 112 and stored therein, although this is not absolutely necessary and the compressed first portion of the input mixed gas stream may be compressed directly into one of the adsorption vessels 106. Regardless of whether the compressed first portion of the input mixed gas stream is introduced into the compressed gas buffer vessel 112, the compressed first portion of the input mixed gas stream is introduced into a first one of the adsorption vessels 106 to provide a first compressed gas mixture within the first adsorption vessel 106. The compressed first portion of the input mixed gas stream is introduced into the first adsorption vessel 106 to provide the first compressed gas mixture within the first adsorption vessel 106 having a pressure in excess of atmospheric pressure, typically at least 10 bara (bar absolute), and normally within the range of 10 to 30 bara. The carbon dioxide sorbent material contained in the first absorption vessel 106 adsorbs carbon dioxide from the first compressed gas mixture, thus reducing the concentration of carbon dioxide in the first compressed gas mixture. Once sufficient carbon dioxide has been adsorbed by the sorbent and the concentration of carbon dioxide in the first compressed gas mixture reduces below a certain level, a carbon dioxide depleted fraction of the first compressed gas mixture is vented from the first adsorption vessel 106, for example via valve 116. The carbon dioxide depleted fraction, or simply depleted fraction, has a concentration of carbon dioxide lower than that of the input mixed gas stream.

The vented depleted fraction may be decompressed and kinetic energy resulting from the decompression may be recovered from the depleted fraction by passing the vented depleted fraction through the energy recovery system 128. The energy recovery system may convert the kinetic energy into electrical energy, which may be stored or otherwise used. For example, the recovered energy may be used to operate the gas compression system 104, thereby reducing energy loses by the system and making the process more energy efficient. However, as will be appreciated, it is not absolutely necessary to recover kinetic energy from the depleted fraction to achieve other benefits of the invention and this step may therefore be omitted from the method.

Once the pressure within the first adsorption vessel 106 reduces due to the venting of the depleted fraction, carbon dioxide is desorbed from the sorbent material within the adsorption vessel 106. A carbon dioxide enriched fraction of the first compressed gas mixture is then vented from the first adsorption vessel 106, for example via valve 118. The carbon dioxide enriched fraction comprises carbon dioxide desorbed from the sorbent material and has a concentration of carbon dioxide higher than that of the input mixed gas stream. The pressure within the adsorption vessel 106 may be allowed to reduce, or may be reduced, to ambient pressure or below (e.g. a vacuum), for example ambient atmospheric pressure or below, and the carbon dioxide enriched fraction may comprise carbon dioxide desorbed from the sorbent at ambient pressure or below. The carbon dioxide enriched fraction may be collected, for example via the outlet port 124, and subsequently stored or used.

An intermediate or middle fraction of the first compressed gas mixture is vented from the first adsorption vessel 106, for example via valve 120, between the venting of the depleted and enriched fractions. The intermediate fraction has a concentration of carbon dioxide higher than that of the input gas mixture but lower than that of the vented enriched fraction. The intermediate fraction is therefore used to enrich (i.e. increase) the concentration of carbon dioxide in the compressed gas mixture fed into an adsorption vessel 106 of the system in a subsequent PSA cycle by mixing it with the input mixed gas stream. The intermediate fraction is therefore recycled through the gas compression system 104 and compressed gas buffer vessel 112 and combined with a portion of the input mixed gas stream to provide the compressed gas mixture that is fed into an adsorption vessel 106 of the system in a subsequent PSA cycle. In particular, in a subsequent PSA cycle, the intermediate fraction is combined or mixed with the portion of the input mixed gas stream to provide the compressed gas mixture. For example, in the subsequent PSA cycle, the intermediate fraction may be fed into the compressed gas buffer vessel via the gas compression system 104 and mixed with a portion of the input mixed gas stream to provide a compressed gas mixture, which is then fed into an adsorption vessel 106 of the system from the compressed gas buffer vessel 112. This adsorption vessel 106 need not be a different adsorption vessel to the first adsorption vessel 106, and may indeed by the same adsorption vessel as the first adsorption vessel. For example, the system may comprise only a single adsorption vessel. However, it is possible for the system to comprise a plurality of adsorption vessels, as illustrated in FIG. 1, in which case the adsorption vessel 106 into which the further compressed gas mixture is fed may indeed be a different adsorption vessel from the first. Using a parallel arrangement of adsorption vessels 106 can increase the throughput of the system by allowing multiple adsorption/desorption cycles to be performed in parallel. As used herein, and as will be appreciated by those skilled in the art, an adsorption/desorption (or adsorb/desorb) cycle refers to the process of adsorbing and desorbing carbon dioxide from the compressed gas within an adsorption vessel 106 and the venting of the various fractions. An adsorption/desorption cycle begins with the introduction of the compressed gas into the adsorption vessel 106 and terminates with the venting of the carbon dioxide enriched fraction. The system therefore performs a plurality of adsorption/desorption cycles using the one or more adsorption vessels 106, and the intermediate fraction from a given adsorption/desorption cycle may be combined with a portion of the compressed input mixed gas stream to form a carbon dioxide enriched compressed gas mixture used in a subsequent adsorption/desorption cycle. Each adsorption/desorption cycle forms a part of an overall PSA cycle performed by the system.

The method may therefore comprise venting, from the first adsorption vessel 106, via valve 120, an intermediate fraction of the first compressed gas mixture having a concentration of carbon dioxide higher than that of the input gas mixture but lower than that of the enriched fraction of the first compressed gas mixture. The intermediate fraction may then be introduced into a second adsorption vessel 106 (which may be the same or different from the first adsorption vessel) along with a compressed second portion of the input mixed gas stream to provide a second compressed gas mixture within the second adsorption vessel 106. For example, the vented intermediate fraction and the second portion of the input mixed gas stream may be fed into the compressed gas buffer vessel 112 via the gas compression system 104 and the compressed vented intermediate fraction and second portion of the input mixed gas stream may be stored in the compressed gas buffer vessel 112. The compressed intermediate fraction and the compressed second portion of the input mixed gas stream may then be introduced into an adsorption vessel 106 from the compressed gas buffer vessel 112. The rest of the second/subsequent PSA cycle may then be as described above in relation to the first PSA cycle. Specifically, the carbon dioxide sorbent material contained in the second absorption vessel 106 then adsorbs carbon dioxide from the second compressed gas mixture, and a carbon dioxide depleted fraction may be vented from the second adsorption vessel 106, followed by the venting of a carbon dioxide enriched fraction and, optionally, an intermediate fraction, which may then be fed one again into a subsequent PSA cycle. As for the first PSA cycle, the vented carbon dioxide depleted fraction of the second compressed gas mixture may be decompressed, and kinetic energy recovered from the carbon dioxide depleted fraction by the energy recovery system 104, using either the same or a different energy recovery unit from that used in the first cycle.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the appended claims.

Although the appended claims are directed to particular combinations of features, it should be understood that the present disclosure also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features that are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the devices and systems described may be incorporated into/used in corresponding methods.

For the sake of completeness, it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

### EXAMPLES

Methods and systems according to the invention have been used to refine carbon dioxide from input mixed gas streams.

### First Trial

A system according to the invention was used to refine an input mixed gas stream of 20 vol % carbon dioxide in nitrogen to 70 vol %.

194-214 litres of 20 vol % carbon dioxide in nitrogen input gas were processed over a period of 3-5 minutes. The process yielded, in a single pass (with no pre-enrichment), 32 litres of enriched carbon dioxide at 60-80 vol % purity (i.e. 25.4 litres of pure carbon dioxide). Thus, this process captured up to 65% of the carbon dioxide into the richer stream.

### Second Trial

Intermediate fractions were taken from the adsorption vessel and mixed with the input mixed gas stream. The concentration of carbon dioxide in the input mixed gas stream increased from 20 vol % to 25 vol %.

Using pre-enrichment to increase the proportion of carbon dioxide in the mixed input gas stream to around 25 vol %, the concentration of carbon dioxide in the enriched fraction was increased to 70-90 vol %, or even higher.

This shows that the carbon dioxide concentration of the input gas stream can be increased using intermediate fractions from adsorption vessels. This allows the overall process to be more efficient.

### Third Trial

800 litres of 30 vol % carbon dioxide in nitrogen input gas were processed over a period of 3-5 minutes using a four-column (i.e. adsorption vessel) process with pre-enrichment using intermediate gas portions. The concentration of the resulting enriched gas was over 90 vol % carbon dioxide.

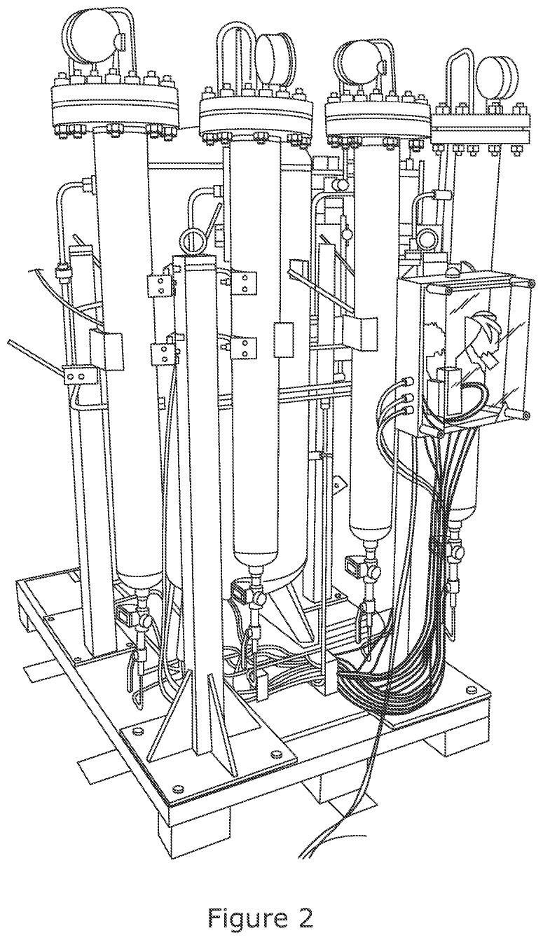

FIG. 2 shows a photograph of the apparatus used for the second and third trials.

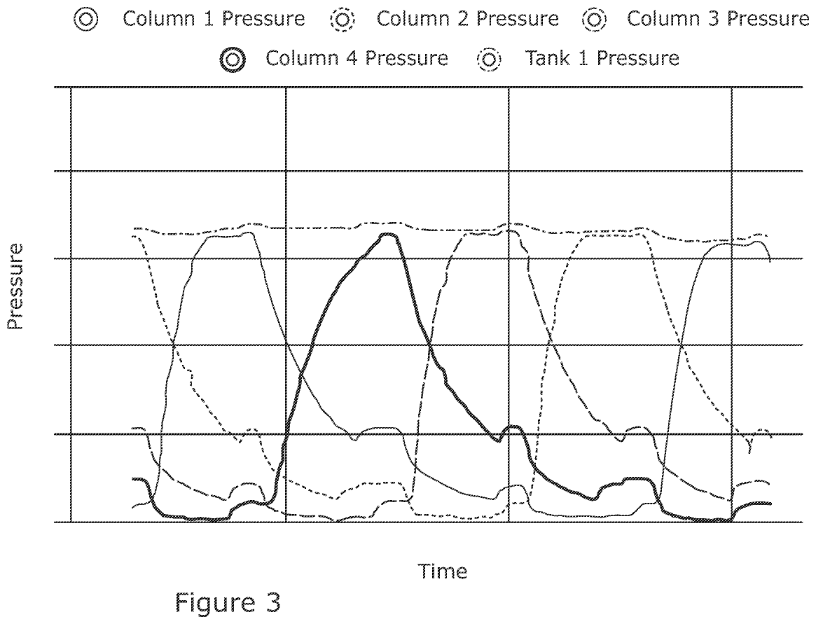

FIG. 3 shows typical pressures in the four columns (i.e. adsorption vessels) and the input tank of the apparatus over time. It can be seen that there is a small decrease in the pressure in the input tank as each of the columns are filled, and the pressure is topped up with fresh input mixed gas and the “recycled” intermediate fraction. However, because the adsorption steps and the desorption steps in the columns are offset in time between the columns, there is a minimal pressure variation in the input tank over time.

As best illustrated by the Column 1 pressure, the pressure in each column increases as the input mixed gas stream is introduced to the column, and the pressure is highest when this stage is complete. The pressure drops as the depleted gas is vented. There is typically a small rebound period where the pressure rises due to a water hammer-like effect. Then a smaller drop in pressure is caused by the venting (and recycling) of the intermediate gas fraction. A final pressure drop is then observed during the venting of the enriched fraction.

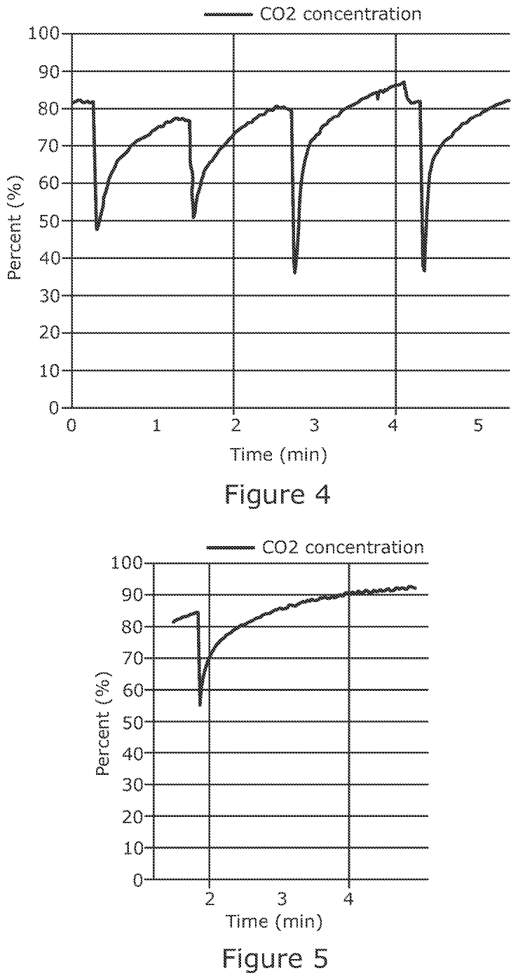

FIG. 4 shows the typical concentration of the enriched carbon dioxide fraction over time. The output gas had a concentration of around 80 vol % carbon dioxide.

The downward spike in concentration is an artefact due to the output switching to the next adsorber column in the sequence. In particular, there is usually a small amount of depleted gas still in the lines, and the carbon dioxide sensor can take a moment to re-adjust following a drop or spike in pressure.

It can be seen that the carbon dioxide concentration of the enriched fraction generally increases progressively from one cycle to the next. This is due to the pre-enrichment of the input mixed gas stream by recycling the intermediate fraction of each cycle.

The kinetic energy from the vented carbon dioxide depleted fractions was successfully recovered using either a turbine generator, to produce an indicated electrical current, or using a reciprocating piston pump, to produce compressed gas.

FIG. 5 shows the carbon dioxide concentration profile of the enriched fraction over the course of an extended enriched fraction venting stage. It illustrates that the carbon dioxide concentration of the enriched fraction can be increased by prolonging the venting of the enriched fraction, for example by venting the enriched fraction until a lower low pressure endpoint.

It has therefore been shown that pre-enrichment of the input mixed gas stream, by taking an intermediate fraction during the venting stage and combining this with the input mixed gas stream for a subsequent adsorption cycle, can increase the maximum achievable carbon dioxide concentration (e.g. by 10%), and/or increase the total volume of the output gas at a predetermined carbon dioxide concentration.

As some the proportion of carbon dioxide in the enriched fraction can be increased using pre-enrichment, pre-enrichment allows the upper pressure limit for the enriched fraction to be increased to therefore achieve a larger volume of gas that contains the same proportion of carbon dioxide.

1. A method for refining carbon dioxide from an input mixed gas stream comprising carbon dioxide, the method comprising;
introducing a compressed first portion of the input mixed gas stream into a first adsorption vessel containing carbon dioxide sorbent material to provide a first compressed gas mixture within the first adsorption vessel;
venting, from the first adsorption vessel, a carbon dioxide depleted fraction of the first compressed gas mixture;
venting, from the first adsorption vessel, an intermediate fraction of the first compressed gas mixture;
venting, from the first adsorption vessel, a carbon dioxide enriched fraction of the first compressed gas mixture, wherein the intermediate fraction of the first compressed gas mixture has a concentration of carbon dioxide higher than that of the input gas mixture but lower than that of the enriched fraction of the first compressed gas mixture;
collecting the carbon dioxide enriched fraction of the first compressed gas mixture;
introducing the intermediate fraction of the first compressed gas mixture and a compressed second portion of the input mixed gas stream into a second adsorption vessel containing carbon dioxide sorbent material to provide a second compressed gas mixture within the second adsorption vessel;
venting, from the second adsorption vessel, a carbon dioxide depleted fraction of the second compressed gas mixture;
venting, from the second adsorption vessel, a carbon dioxide enriched fraction of the second compressed gas mixture; and
collecting the carbon dioxide enriched fraction of the second compressed gas mixture.

2. The method of claim 1, further comprising;
introducing the vented intermediate fraction of the first compressed gas mixture and the compressed second portion of the input mixed gas stream into a compressed gas buffer vessel; and
introducing the intermediate fraction of the first compressed gas mixture and the compressed second portion of the input mixed gas stream into the second adsorption vessel from the compressed gas buffer vessel.

3. The method of claim 2, further comprising compressing the vented intermediate fraction of the first compressed gas mixture and introducing the compressed vented intermediate fraction of the first compressed gas mixture into the compressed gas buffer vessel.

4. The method of claim 1, further comprising controlling the pressure of the compressed gas mixture, and/or the pressure range(s) within which the carbon dioxide depleted fraction, the intermediate fraction and/or the enriched fraction is/are vented.

5. The method of claim 1, further comprising controlling the carbon dioxide concentration of the compressed gas mixture, and/or the range(s) of carbon dioxide concentration within which the carbon dioxide depleted fraction and/or the intermediate fraction is/are vented.

6. (canceled)

7. The method of claim 1, wherein the first adsorption vessel and the second adsorption vessel are different vessels, and wherein the adsorption step in the first adsorption vessel is offset in time from the adsorption step in the second adsorption vessel, and wherein the desorption step in the first adsorption vessel is offset in time from the desorption in the second adsorption vessel.

8.-10. (canceled)

11. The method of claim 1, further comprising;
decompressing the vented carbon dioxide depleted fraction of the first compressed gas mixture; and
recovering kinetic energy from the carbon dioxide depleted fraction of the first compressed gas mixture resulting from decompression of the vented carbon dioxide depleted fraction of the first compressed gas mixture.

12. The method of claim 11, wherein recovering kinetic energy from the carbon dioxide depleted fraction of the first compressed gas mixture comprises passing the vented carbon dioxide depleted fraction of the first compressed gas mixture through an energy recovery system to recover the kinetic energy from the carbon dioxide depleted fraction of the first compressed gas mixture.

13. The method of claim 12, wherein the energy recovery system comprises an energy recovery unit through which the vented carbon dioxide depleted fraction of the first compressed gas mixture is passed to recover the kinetic energy from the carbon dioxide depleted fraction of the first compressed gas mixture.

14. The method of claim 13, wherein the energy recovery unit comprises a turbine and/or a piston.

15. The method of claim 1, further comprising compressing the first portion of the input mixed gas stream.

16. (canceled)

17. The method of claim 1, wherein venting, from the first adsorption vessel, the carbon dioxide enriched fraction of the first compressed gas mixture comprises venting, from the first adsorption vessel, carbon dioxide desorbed from the sorbent material at ambient atmospheric pressure or lower.

18. (canceled)

19. A pressure swing adsorption system for performing the method of claim 1.

20. A pressure swing adsorption system for refining carbon dioxide from an input mixed gas stream comprising carbon dioxide, the system comprising;
a gas inlet for receiving an input mixed gas stream;
a gas compression system in fluid communication with the gas inlet;
a first adsorption vessel containing carbon dioxide sorbent material, the first adsorption vessel in fluid communication with the gas compression system and configured to receive gas compressed by the gas compression system;
an energy recovery system in fluid communication with the first adsorption vessel, the energy recovery system configured to recover kinetic energy resulting from the decompression of compressed gas vented from the first adsorption vessel;
a second adsorption vessel containing carbon dioxide sorbent material, the second adsorption vessel in fluid communication with the gas compression system and configured to receive gas compressed by the gas compressor; and
wherein the system is configured to;
vent, from the first adsorption vessel, an intermediate fraction of the first compressed gas mixture having a concentration of carbon dioxide higher than that of the input gas mixture but lower than that of the enriched fraction of the first compressed gas mixture;
compress, using the gas compression system, a second portion of the input mixed gas stream;
introduce the intermediate fraction of the first compressed gas mixture and the compressed second portion of the input mixed gas stream into the first or second adsorption vessel to provide a second compressed gas mixture within the first or second adsorption vessel;
vent, from the first or second adsorption vessel, a carbon dioxide depleted fraction of the second compressed gas mixture; and
vent, from the first or second adsorption vessel, a carbon dioxide enriched fraction of the second compressed gas mixture.

21. The system of claim 20, wherein the energy recovery system is configured to recover kinetic energy resulting from the decompression of a carbon dioxide depleted portion of the compressed gas vented from the first adsorption vessel.

22. The system of claim 20, further comprising a controller configured to control the system to;
compress, using the gas compression system, a first portion of the input mixed gas stream;
introduce the compressed first portion of the input mixed gas stream into the first adsorption vessel to provide a first compressed gas mixture within the first adsorption vessel;
vent, from the first adsorption vessel, a carbon dioxide depleted fraction of the first compressed gas mixture;
decompress the vented carbon dioxide depleted fraction of the first compressed gas mixture;
pass the vented carbon dioxide depleted fraction of the first compressed gas mixture through the energy recovery system to recover kinetic energy from the carbon dioxide depleted fraction of the first compressed gas mixture; and
vent, from the first adsorption vessel, a carbon dioxide enriched fraction of the first compressed gas mixture.

23. The system of claim 22, wherein the controller is configured to control the system to;
vent, from the first adsorption vessel, an intermediate fraction of the first compressed gas mixture having a concentration of carbon dioxide higher than that of the input gas mixture but lower than that of the enriched fraction of the first compressed gas mixture;
compress, using the gas compression system, a second portion of the input mixed gas stream;
introduce the intermediate fraction of the first compressed gas mixture and the compressed second portion of the input mixed gas stream into the first or second adsorption vessel to provide a second compressed gas mixture within the first or second adsorption vessel;
vent, from the first or second adsorption vessel, a carbon dioxide depleted fraction of the second compressed gas mixture; and
vent, from the first or second adsorption vessel, a carbon dioxide enriched fraction of the second compressed gas mixture.

24. The system of claim 23, further comprising a first gas return path in fluid communication with the first adsorption vessel and an inlet of the gas compression system, the first gas return path configured to return the intermediate fraction of the first compressed gas mixture to the gas compressor for compression prior to the introduction of the intermediate fraction of the first compressed gas mixture into the first or second adsorption vessel.

25. The system of claim 23, wherein the controller is configured to control the system to;
decompress the vented carbon dioxide depleted fraction of the second compressed gas mixture; and
pass the vented carbon dioxide depleted fraction of the second compressed gas mixture through the energy recovery system to recover kinetic energy from the carbon dioxide depleted fraction of the second compressed gas mixture.

26. The system of claim 20, further comprising;
a compressed gas buffer vessel in fluid communication with the gas compression system and the first adsorption vessel, the compressed gas buffer vessel configured receive and store compressed gas compressed by the gas compression system prior to the compressed gas being introduced into the first adsorption vessel.
